(19) United States
(12) Patent Application Publication
(10) Pub. No.: US 2012/0107135 A1
(43) Pub. Date: May 3, 2012

(54) APPARATUS, SYSTEMS AND METHODS FOR COOLING THE PLATFORM REGION OF TURBINE ROTOR BLADES

(75) Inventors: John Wesley Harris, JR., Taylors, SC (US); Daniel Howard Tragesser, Simpsonville, SC (US); Anthony Louis Giglio, Simpsonville, SC (US)

(73) Assignee: General Electric Company

(21) Appl. No.: 12/915,501

(22) Filed: Oct. 29, 2010

(51) Int. Cl. F01D 5/18; B23P 15/02

(52) U.S. Cl. 416/97 R; 29/889.721

(57) ABSTRACT

A platform cooling arrangement in a turbine rotor blade having a platform at an interface between an airfoil and a root, wherein the rotor blade includes an interior cooling passage that extends to the approximate radial height of the platform, and wherein, a pressure side of the platform comprises a planar topside that extends circumferentially from the airfoil to a pressure side slashface, and a suction side of the platform comprises a substantially planar topside that extends circumferentially from the airfoil to a suction side slashface. The platform cooling arrangement may include a linear plenum residing just inboard of the planar topside and linearly extending through the platform from either the pressure side slashface or the suction side slashface to a connection with the interior cooling passage, the linear plenum having a longitudinal axis that is approximately parallel to the planar topside; and a plurality of cooling apertures linearly extending from a topside outlet formed on the topside of the platform to a connection with the linear plenum, wherein the cooling apertures are configured such that each forms an acute angle with the topside of the platform.

### BACKGROUND OF THE INVENTION

The present application relates generally to combustion turbine engines, which, as used herein and unless specifically stated otherwise, includes all types of combustion turbine engines, such as those used in power generation and aircraft engines. More specifically, but not by way of limitation, the present application relates to apparatus, systems and/or methods for cooling the platform region of turbine rotor blades.

A gas turbine engine typically includes a compressor, a combustor, and a turbine. The compressor and turbine generally include rows of airfoils or blades that are axially stacked in stages. Each stage typically includes a row of circumferentially spaced stator blades, which are fixed, and a set of circumferentially spaced rotor blades, which rotate about a central axis or shaft. In operation, the rotor blades in the compressor are rotated about the shaft to compress a flow of air. The compressed air is then used within the combustor to combust a supply of fuel. The resulting flow of hot gases from the combustion process is expanded through the turbine, which causes the rotor blades to rotate the shaft to which they are attached. In this manner, energy contained in the fuel is converted into the mechanical energy of the rotating shaft, which then, for example, may be used to rotate the coils of a generator to generate electricity.

Referring to FIGS. 1 and 2, turbine rotor blades 100 generally include an airfoil portion or airfoil 102 and a root portion or root 104. The airfoil 102 may be described as having a convex suction face 105 and a concave pressure face 106. The airfoil 102 further may be described as having a leading edge 107, which is the forward edge, and a trailing edge 108, which is the aft edge. The root 104 may be described as having structure (which, as shown, typically includes a dovetail 109) for affixing the blade 100 to the rotor shaft, a platform 110 from which the airfoil 102 extends, and a shank 112, which includes the structure between the dovetail 109 and the platform 110.

As illustrated, the platform 110 may be substantially planar. More specifically, the platform 110 may have a planar topside 113, which, as shown in FIG. 1, may include an axially and circumferentially extending flat surface. As shown in FIG. 2, the platform 110 may have a planar underside 114, which may also include an axially and circumferentially extending flat surface. The topside 113 and the bottom side 114 of the platform 110 may be formed such that each is substantially parallel to the other. As depicted, it will be appreciated that the platform 110 typically has a thin radial profile, i.e., there is a relatively short radial distance between the topside 113 and the bottom side 114 of the platform 110.

In general, the platform 110 is employed on turbine rotor blades 100 to form the inner flow path boundary of the hot gas path section of the gas turbine. The platform 110 further provides structural support for the airfoil 102. In operation, the rotational velocity of the turbine induces mechanical loading that creates highly stressed regions along the platform 110 that, when coupled with high temperatures, ultimately cause the formation of operational defects, such as oxidation, creep, low-cycle fatigue cracking, and others. These defects, of course, negatively impact the useful life of the rotor blade 100. It will be appreciated that these harsh operating conditions, i.e., exposure to extreme temperatures of the hot gas path and mechanical loading associated with the rotating blades, create considerable challenges in designing durable, long-lasting rotor blade platforms 110 that both perform well and are cost-effective to manufacture.

One common solution to make the platform region 110 more durable is to cool it with a flow of compressed air or other coolant during operation, and a variety of these type of platform designs are known. However, as one of ordinary skill in the art will appreciate, the platform region 110 presents certain design challenges that make it difficult to cool in this manner. In significant part, this is due to the awkward geometry of this region, in that, as described, the platform 110 is a periphery component that resides away from the central core of the rotor blade and typically is designed to have a structurally sound, but thin radial thickness.

To circulate coolant, rotor blades 100 typically include one or more hollow cooling passages 116 (see FIGS. 3, 4, 5, and 9) that, at minimum, extend radially through the core of the blade 100, including through the root 104 and the airfoil 102. As described in more detail below, to increase the exchange of heat, such cooling passages 116 may be formed having a serpentine path that winds through the central regions of the blade 100, though other configurations are possible. In operation, a coolant may enter the central cooling passages via one or more inlets 117 formed in the inboard portion of the root 104. The coolant may circulate through the blade 100 and exit through outlets (not shown) formed on the airfoil and/or via one or more outlets (not shown) formed in the root 104. The coolant may be pressurized, and, for example, may include pressurized air, pressurized air mixed with water, steam, and the like. In many cases, the coolant is compressed air that is diverted from the compressor of the engine, though other sources are possible. As discussed in more detail below, these cooling passages typically include a high-pressure coolant region and a low-pressure coolant region. The high-pressure coolant region typically corresponds to an upstream portion of the cooling passage that has a higher coolant pressure, whereas the low-pressure coolant region corresponds to a downstream portion having a relatively lower coolant pressure.

In some cases, the coolant may be directed from the cooling passages 116 into a cavity 119 formed between the shanks 112 and platforms 110 of adjacent rotor blades 100. From there, the coolant may be used to cool the platform region 110 of the blade, a conventional design of which is presented in FIG. 3. This type of design typically extracts air from one of the cooling passages 116 and uses the air to pressurize the cavity 119 formed between the shanks 112/platforms 110. Once pressurized, this cavity 119 then supplies coolant to cooling channels that extend through the platforms 110. After traversing the platform 110, the cooling air may exit the cavity through film cooling holes formed in the topside 113 of the platform 110.

It will be appreciated, however, that this type of conventional design has several disadvantages. First, the cooling circuit is not self-contained in one part, as the cooling circuit is only formed after two neighboring rotor blades 100 are assembled. This adds a great degree of difficulty and complexity to installation and pre-installation flow testing. A second disadvantage is that the integrity of the cavity 119 formed between adjacent rotor blades 100 is dependent on how well the perimeter of the cavity 119 is sealed. Inadequate sealing may result in inadequate platform cooling and/or wasted cooling air. A third disadvantage is the inherent risk that hot gas path gases may be ingested into the cavity 119 or the platform itself 110. This may occur if the cavity 119 is not maintained at a sufficiently high pressure during operation. If the pressure of the cavity 119 falls below the pressure within the hot gas path, hot gases will be ingested into the shank cavity 119 or the platform 110 itself, which typically damages these components as they were not designed to endure exposure to the hot gas-path conditions.

FIGS. 4 and 5 illustrate another type of conventional design for platform cooling. In this case, the cooling circuit is contained within the rotor blade 100 and does not involve the shank cavity 119, as depicted. Cooling air is extracted from one of the cooling passages 116 that extend through the core of the blade 110 and directed aft through cooling channels 120 formed within the platform 110 (i.e., “platform cooling channels 120”). As shown by the several arrows, the cooling air flows through the platform cooling channels 120 and exits through outlets in the aft edge 121 of the platform 110 or from outlets disposed along the suction side edge 122. (Note that in describing or referring to the edges or faces of the rectangular platform 110, each may be delineated based upon its location in relation to the suction face 105 and pressure face 106 of the airfoil 102 and/or the forward and aft directions of the engine once the blade 100 is installed. As such, as one of ordinary skill in the art will appreciate, the platform may include an aft edge 121, a suction side edge 122, a forward edge 124, and a pressure side edge 126, as indicated in FIGS. 3 and 4. In addition, the suction side edge 122 and the pressure side edge 126 also are commonly referred to as “slashfaces” and the narrow cavity formed therebetween once neighboring rotor blades 100 are installed may be referred to as a “slashface cavity”.)

It will be appreciated that the conventional designs of FIGS. 4 and 5 have an advantage over the design of FIG. 3 in that they are not affected by variations in assembly or installation conditions. However, conventional designs of this nature have several limitations or drawbacks. First, as illustrated, only a single circuit is provided on each side of the airfoil 102 and, thus, there is the disadvantage of having limited control of the amount of cooling air used at different locations in the platform 110. Second, conventional designs of this type have a coverage area that is generally limited. While the serpentine path of FIG. 5 is an improvement in terms of coverage over FIG. 4, there are still dead areas within the platform 110 that remain uncooled. Third, to obtain better coverage with intricately formed platform cooling channels 120, manufacturing costs increase dramatically, particularly if the cooling channels having shapes that require a casting process to form. Fourth, these conventional designs typically dump coolant into the hot gas path after usage and before the coolant is completely exhausted, which negatively affects the efficiency of the engine. Fifth, conventional designs of this nature generally have little flexibility. That is, the channels 120 are formed as an integral part of the platform 110 and provide little or no opportunity to change their function or configuration as operating conditions vary. In addition, these types of conventional designs are difficult to repair or refurbish.

As a result, conventional platform cooling designs are lacking in one or more important areas. There remains a need for improved apparatus, systems, and methods that effectively and efficiently cool the platform region of turbine rotor blades, while also being cost-effective to construct, flexible in application, and durable.

### BRIEF DESCRIPTION OF THE INVENTION

The present application thus describes a platform cooling arrangement in a turbine rotor blade having a platform at an interface between an airfoil and a root, wherein the rotor blade includes an interior cooling passage that extends from the root to at least the approximate radial height of the platform, and wherein, along a side that corresponds with a pressure face of the airfoil, a pressure side of the platform comprises a substantially planar topside that extends circumferentially from the airfoil to a pressure side slashface, and, along a side that corresponds with a suction face of the airfoil, a suction side of the platform comprises a substantially planar topside that extends circumferentially from the airfoil to a suction side slashface. The platform cooling arrangement may include a linear plenum residing just inboard of the planar topside and linearly extending through the platform from either the pressure side slashface or the suction side slashface to a connection with the interior cooling passage, the linear plenum having a longitudinal axis that is approximately parallel to the planar topside; and a plurality of cooling apertures linearly extending from a topside outlet formed on the topside of the platform to a connection with the linear plenum, wherein the cooling apertures are configured such that each forms an acute angle with the topside of the platform.

The present application further describes a method of creating a platform cooling arrangement in a turbine rotor blade having a platform at an interface between an airfoil and a root, wherein the rotor blade includes an interior cooling passage that extends from the root to at least the approximate radial height of the platform, and wherein, along a side that corresponds with a pressure face of the airfoil, a pressure side of the platform comprises a planar topside that extends circumferentially from the airfoil to a pressure side slashface, and, along a side that corresponds with a suction face of the airfoil, a suction side of the platform comprises a planar topside that extends circumferentially from the airfoil to a suction side slashface. The method may include the steps of: machining at least one linear plenum, the linear plenum configured to reside just inboard of the planar topside and linearly extend through the platform from a starting point at a position on either the pressure side slashface or the suction side slashface to a connection with the interior cooling passage, the linear plenum having a longitudinal axis that is approximately parallel to the planar topside; and machining a plurality of cooling apertures that linearly extend from a starting point at a position on the topside of the platform to a connection with the linear plenum, wherein the cooling apertures are configured such that each forms an acute angle with the topside of the platform, the acute angle comprising an angle of less than 60°.

These and other features of the present application will become apparent upon review of the following detailed description of the preferred embodiments when taken in conjunction with the drawings and the appended claims.

### BRIEF DESCRIPTION OF THE DRAWINGS

These and other features of this invention will be more completely understood and appreciated by careful study of the following more detailed description of exemplary embodiments of the invention taken in conjunction with the accompanying drawings, in which:

FIG. 1 illustrates a perspective view of an exemplary turbine rotor blade in which embodiments of the present invention may be employed;

FIG. 2 illustrates an underside view of a turbine rotor blade in which embodiments of the present invention may be used;

FIG. 3 illustrates a sectional view of neighboring turbine rotor blades having a cooling system according to conventional design;

FIG. 4 illustrates a top view of a turbine rotor blade having a platform with interior cooling channels according to conventional design;

FIG. 5 illustrates a top view of a turbine rotor blade having a platform with interior cooling channels according to an alternative conventional design;

FIG. 6 illustrates a perspective view of a turbine rotor blade having a platform cooling configuration according to an exemplary embodiment of the present invention;

FIG. 7 illustrates a top with partial cross-sectional view of a platform having a cooling configuration according to an exemplary embodiment of the present invention;

FIG. 8 illustrates a cross-sectional side-view of a linear plenum and a connecting cooling aperture according to an exemplary embodiment of the present application;

FIG. 9 illustrates a cross-sectional top-view of a linear plenum and a connecting cooling aperture according to an exemplary embodiment of the present application; and

FIG. 10 illustrates an exemplary method of creating a platform cooling arrangement according to an exemplary embodiment of the present application.

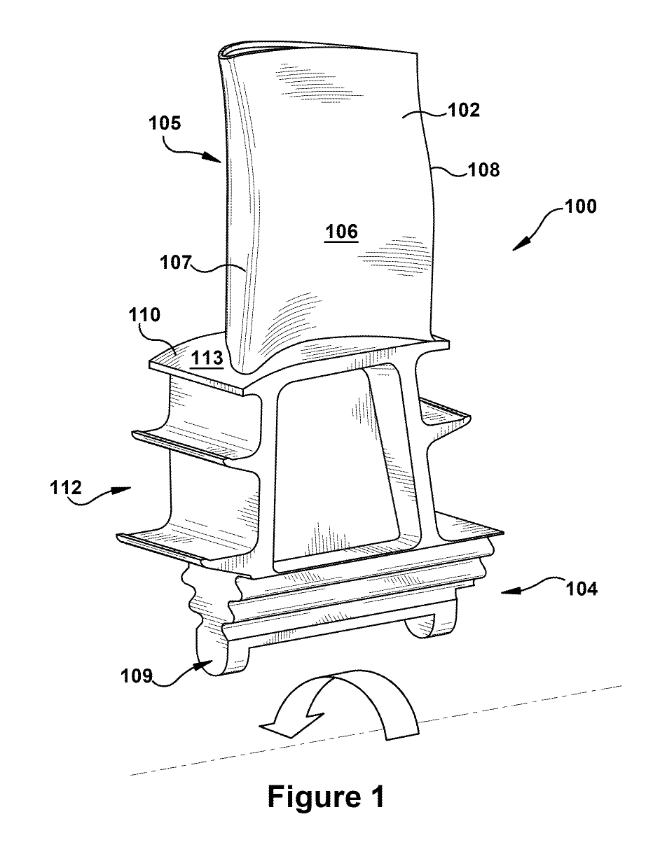

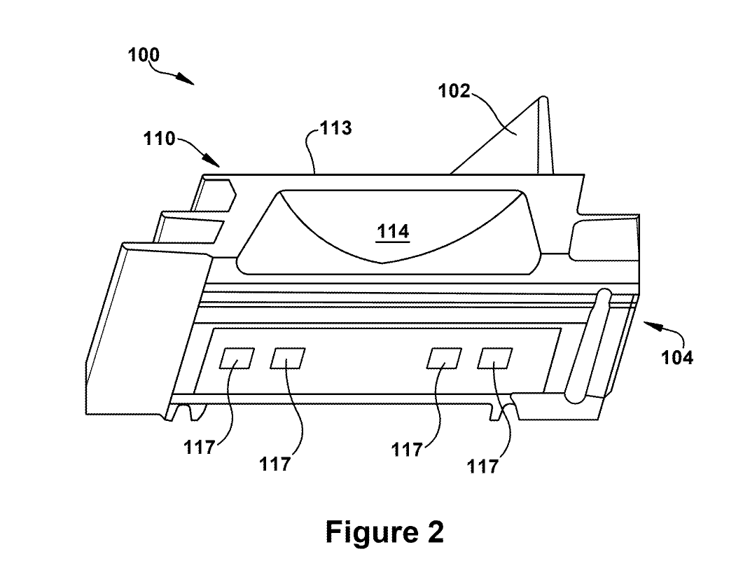

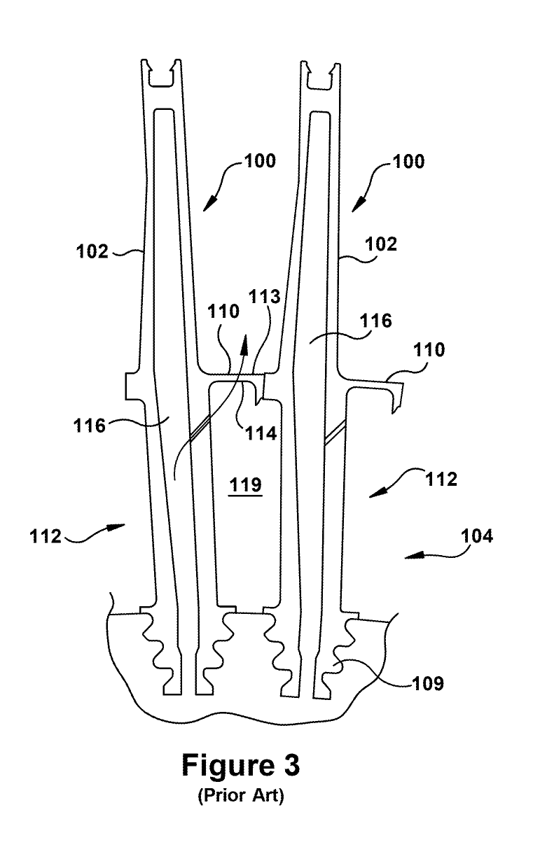

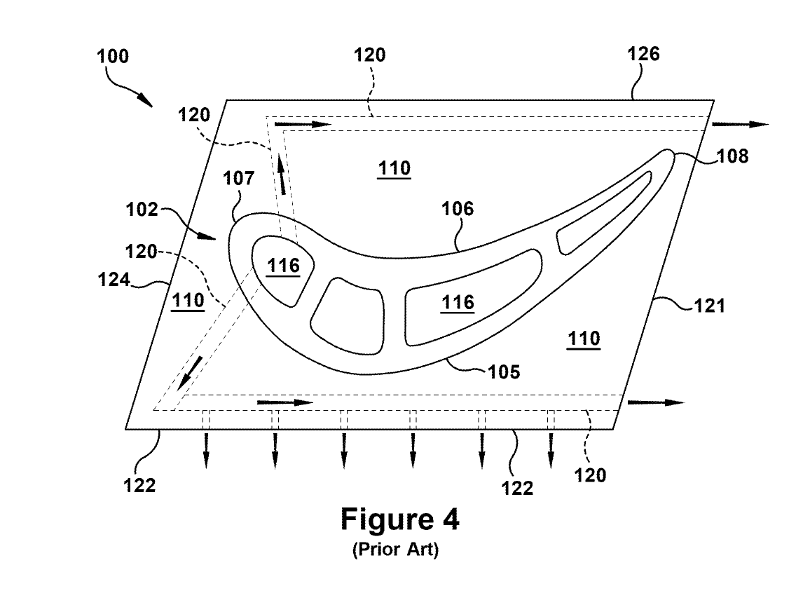

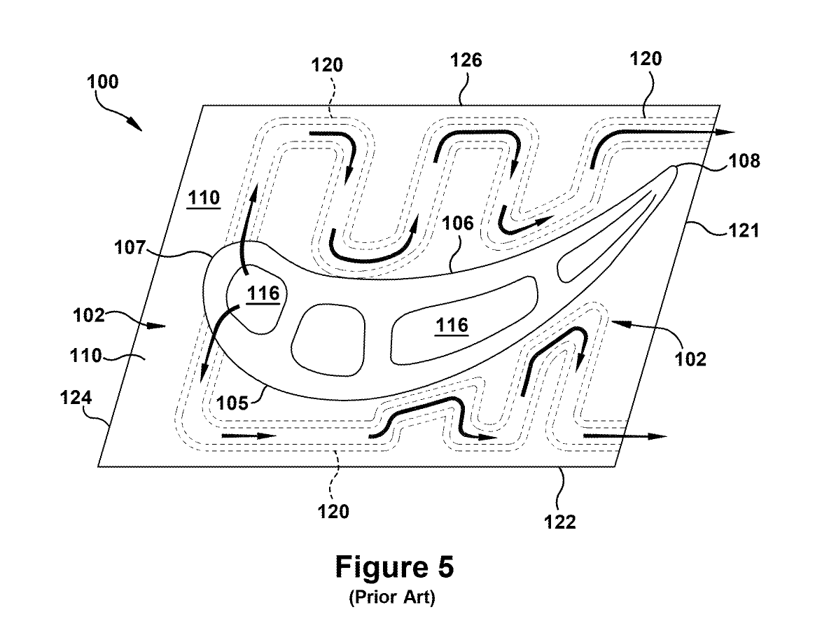

### DETAILED DESCRIPTION OF THE INVENTION

It will be appreciated that cooling configurations of conventional turbine rotor blades 100 typically have an interior cooling passage 116 that extends radially from the root 104 of the blade 100 to a location within the airfoil 102. Typically, the interior cooling passage 116 is configured to form a winding, serpentine path that promotes a one-way flow of coolant and the efficient exchange of heat. In operation, a pressurized coolant, which is typically compressed air and bled from the compressor (though other coolants may be used), is supplied to the interior cooling passage 116. The pressure drives the coolant through the interior cooling passage 116, and the coolant convects heat from the surrounding walls. (It will be appreciated that the present invention may be practiced in rotor blades 100 having internal cooling passages of different configurations and is not limited to cooling passages having a serpentine shape. Accordingly, the term “interior cooling passage” or “cooling passage” is meant to include any passage or hollow channel through which coolant may be circulated in the rotor blade).

In general, the various conventional designs of internal cooling passages 116 are effective at providing active cooling to certain regions within the rotor blade 100. However, as one of ordinary skill in the art will appreciate, the platform region proves more challenging. This, at least in part, is due to the awkward geometry of the platform region—i.e., its narrow radial height and the manner in which it juts away from the core or main body of the rotor blade 100. However, given its exposures to the extreme temperatures of hot gas path and high mechanical loading, the cooling requirements of the platform are considerable. As described above, conventional platform cooling designs are ineffective because they fail to address the particular challenges of the region, are inefficient with their usage of coolant, and/or are costly to fabricate.

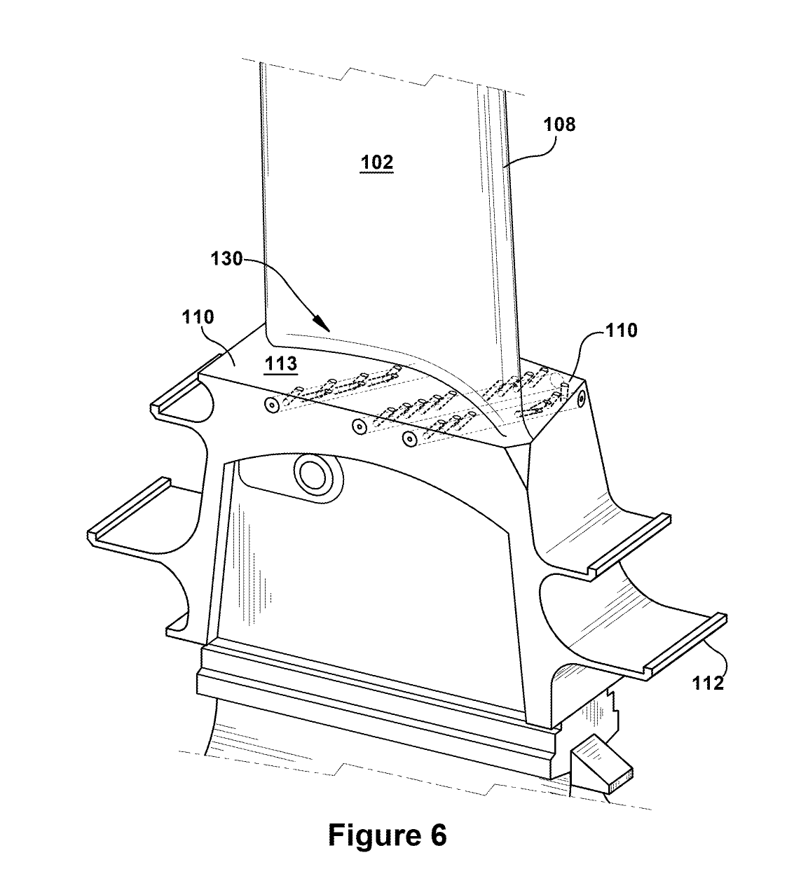

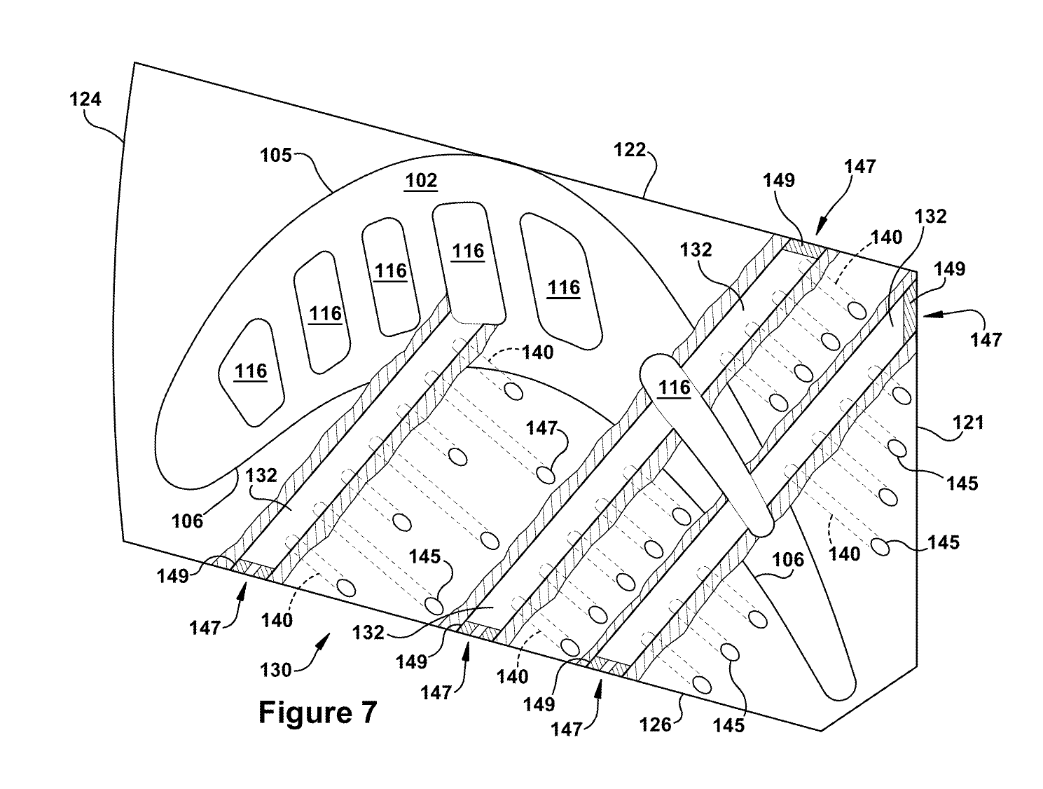

Referring now to FIGS. 6 through 9, several views of exemplary embodiments of the present invention are provided. FIGS. 6 and 7, in particular, illustrate a turbine rotor blade 100 having a platform cooling configuration 130 according to a preferred embodiment of the present invention. As shown, the blade 100 includes a platform 110 residing at the interface between an airfoil 102 and a root 104. The rotor blade 100 includes an interior cooling passage 116 that extends from the root 104 to at least the approximate radial height of the platform 110, and, in most cases, into the airfoil 102. At the side of the platform 110 that corresponds with a pressure face 106 of the airfoil 102, it will be appreciated that the platform 110 may have a planar topside 113 that extends from the airfoil 102 to a pressure side slashface 126. (Note that “planar,” as used herein, means approximately or substantially in the shape of a plane. For example, one of ordinary skill in the art will appreciate that platforms may be configured to have an outboard surface that is slight curved and convex, with the curvature corresponding to the circumference of the turbine at the radial location of the rotor blades. As used herein, this type of platform shape is deemed planar, as the radius of curvature is sufficiently great to give the platform a flat appearance.) At the side of the platform 110 that corresponds with a suction face 105 of the airfoil 102, it will be appreciated that the platform 110 may have a planar topside 113 that extends from the airfoil 102 to a suction side slashface 122. Also configured within the interior of the platform 110, an exemplary embodiment of the present invention may include: one or more linear plenums 132 and a plurality of cooling apertures 140 extending from each.

As illustrated, the linear plenum 132 may be configured such that it resides just inboard of the planar topside 113. The linear plenum 132 may extend in a linear fashion through the platform 110 from either the pressure side slashface 126 or the suction side slashface 122 to a connection with the interior cooling passage 116. The linear plenum 132 may be configured to have a longitudinal axis that is approximately parallel to the planar topside 113. The platform cooling arrangement may have a plurality of linear plenums 132. In some embodiments, as shown in FIG. 7, three linear plenums 132 may be included. As illustrated, the linear plenums 132 may be approximately parallel.

In a preferred embodiment, each of the linear plenums 132 may extend diagonally across the platform 110 (i.e., in relation to the pressure side slashface 126 and the suction side slashface 122). More specifically, from a position on the pressure side slashface 126, the linear plenum 132 may extend along a diagonal path across at least a significant portion of the platform 110. As illustrated, the diagonal path may include an axial-downstream directional component as well as a circumferential directional component. Accordingly, as shown in FIG. 9, a plenum angle 151 may refer to the acute angle formed between the slashface 122, 126 and the linear plenum 132. In preferred embodiments, the plenum angle 151 includes a value of between 45° and 90° More preferably, the plenum angle 151 includes a value of between 60° and 75°.

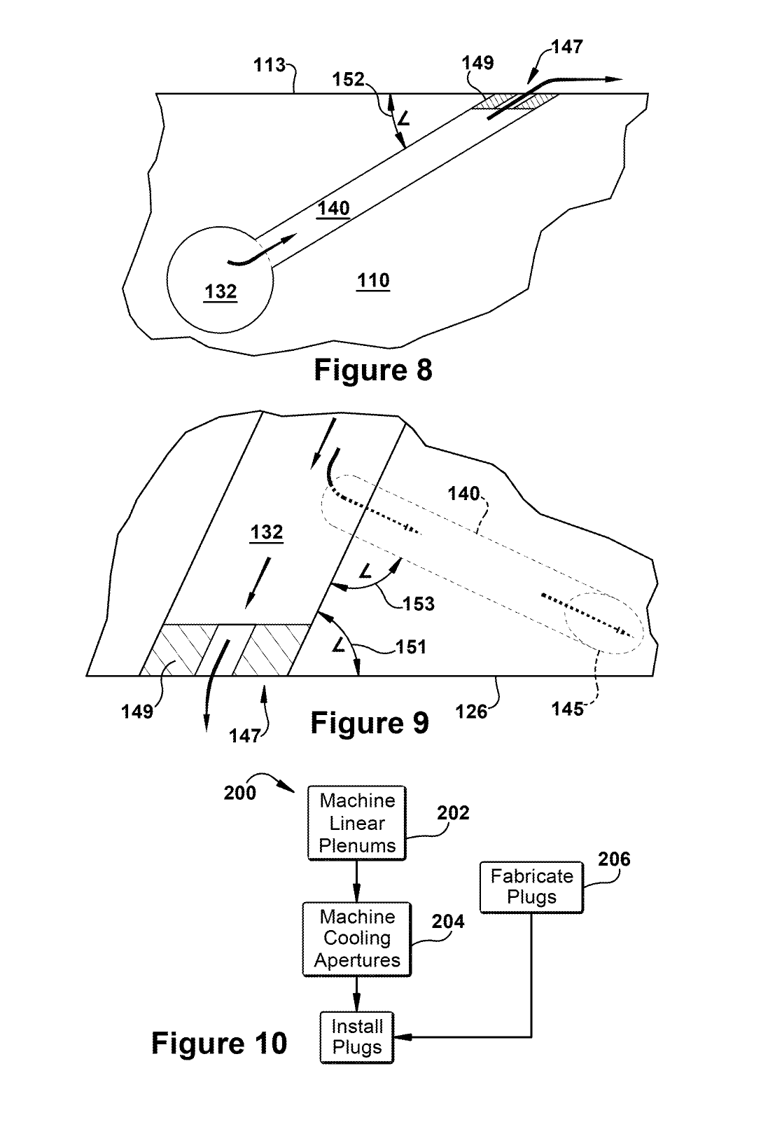

A plurality of cooling apertures 140 may extend in linear fashion from a topside outlet 145 formed through the topside 113 of the platform 110 to a connection made with the linear plenum 132. As shown in FIG. 8, the cooling apertures 140 may be configured such that each forms an oblique angle with the topside 113 of the platform 110. In some embodiments, the acute angle 152 formed between the longitudinal axis of each cooling aperture 140 and the topside 113 of the platform 110 comprises an angle of less than 60°. More preferably, the acute angle 152 formed between the longitudinal axis of each cooling aperture 140 and the topside 113 of the platform 110 comprises an angle of less than 45°. The cooling aperture 140 may be configured such that, in relation to the axial location of the connection each makes with the linear plenum 132, the corresponding topside outlet 145 comprises a downstream location. As shown, in an exemplary embodiment, the cooling apertures 140 may be approximately parallel to each other. In general, the linear plenum 132 and the cooling apertures 140 are configured such that the cross-sectional flow area of the cooling apertures 140 is less than the cross-sectional flow area of the linear plenums 132.

The cooling apertures 140 may be configured to expel coolant in an approximate downstream direction. In some embodiments, the cooling apertures 140 extend diagonally across a portion of the platform 110 from the connection with the linear plenum 132. The diagonal path may include an axial-downstream and a circumferential directional component. As shown in FIG. 7, in some preferred embodiments, the circumferential directional component of the cooling apertures 140 is opposite of the circumferential directional component of the linear plenum 132 from which the cooling aperture 140 extends. In some embodiments, the cooling apertures 140 are approximately parallel to each other and form an angle 153 of approximately 90° to the linear plenum 132 from which each cooling aperture extends.

In some embodiments, the cooling apertures 140 extending from a particular linear plenum 132 may comprise either a short length or long length. In this case, the cooling apertures 140 may have an alternating short/long configuration, where the short length comprises approximately 40%-60% of the long length, as illustrated in FIG. 7.

In one exemplary embodiment, at least two linear plenums 132 are provided: a first linear plenum 132 and a second linear plenum 132. The first linear plenum 132 (which, for the sake of this example, may be thought of as being configured similarly to the forward linear plenum 132 of FIG. 7) may extend from a position on the pressure side slashface 126 to a terminating point at the connection made with the interior cooling passage 116. During operation, this connection may provide a coolant source to the first linear plenum 132. The second linear plenum 132 (which, for the sake of this example, may be thought of as being configured similarly to the middle linear plenum 132 of FIG. 7) may extend from a position on the pressure side slashface 126 across the platform 110 to a position on the suction side slashface 122. On its path across the platform 110, the second linear plenum 132 may be configured to bisect the interior cooling passage 116, which, it will be appreciated, provides a coolant source during operation for the second linear plenum 132.

Each of the first and second linear plenums 132 may include a plurality of cooling apertures 140 that extend therefrom. The second linear plenum 132 may have a plurality of cooling apertures 140 on the pressure side of the platform 110 and a plurality of the cooling apertures 140 on the suction side of the platform 110. In this manner, the second linear plenum 132 may be used to cool either side of the platform 110.

As described, the linear plenums 132 may include one or two slashface outlets 147. The first linear plenum 132, for example, may have a slashface outlet 147 on the pressure side slashface 126. In a preferred embodiment, the slashface outlet 147 may include a reduced cross-sectional flow area. The second linear plenum 132, for example, may have a slashface outlet 147 on the pressure side slashface 126 and a slashface outlet 147 on the suction side slashface 122. In preferred embodiments, the slashface outlet 147 on the pressure side slashface 126 is axially forward of the slashface outlet 147 on the suction side slashface 122. In a preferred embodiment, both slashface outlets 147 of the second linear plenum 132 may have a reduced cross-sectional flow area. As used herein, a reduced cross-sectional flow area comprises a cross-sectional flow area that is less than the cross-sectional flow area through the linear plenum 132 that the slashface outlet 147 serves.

As discussed in more detail below, reducing the cross-sectional flow area of a slashface outlet 147 may be done for at least a couple of reasons. First, the cross-sectional flow area may be reduced to impinge the coolant exiting through these outlet locations. This, as one of ordinary skill in the art will appreciate, may result in the exiting coolant having a desired coolant impingement characteristic, such as a high coolant exit velocity, which would improve its cooling effect on a target surface. Given the location of the slashface outlets 147, it will be appreciated that the slashface outlets 147 may be configured to exhaust an impinged flow of coolant into a slashface cavity that is formed between adjacent installed rotor blades 100. That is, slashface outlets 147 may direct impinged coolant having a relatively high velocity against the slashface of the neighboring turbine blade 100. It will be appreciated that the slashface cavity and the slashfaces that define them are difficult regions of the platform 110 to cool, and that slashface outlets 147 configured in the manner may provide effective cooling to this area.

Second, the cross-sectional flow area of the slashface outlets 147 may be reduced because of the size of the linear plenum 132 and the need to evenly distribute or meter coolant throughout the interior of the platform 110. That is, the linear plenum 132 is designed to distribute coolant to the several cooling apertures 140 with little pressure loss. To accomplish this, the cross-sectional flow area of the linear plenum 132 typically is significantly larger than the cross-sectional flow area of the cooling apertures 140. It will be appreciated that if the slashface outlets 147 were not reduced in size compared to the size of the linear plenum 132, an inordinate amount of coolant would exit the platform 110 through the slashface outlets 147 and the supply of coolant available to the cooling apertures 140 would be likely insufficient. The slashface outlets 147, thus, also may be sized to have a cross-sectional flow area that corresponds to a desired metering characteristic. A “desired metering characteristic,” as used herein, refers to a flow area through the coolant passageway that corresponds or results in a desired distribution of coolant or expected distribution of coolant through the several coolant passageways and/or the outlets that are formed within the platform 110.

In some embodiments, a plug 149 may be used to reduce the cross-sectional flow area of the slashface outlets 147, as illustrated. The plug 149 may be formed such that, upon installation, it reduces the cross-sectional flow area through the cooling passage in which it resides. In this case, the plug 149 is configured to allow a desired level of flow through the passage and directs the remainder through alternative routes. As used herein, plugs of this type will be referred to “as partial plugs.” Accordingly, the partial plug 149 may be configured to be inserted into the slashface outlet 147 and reduce its cross-sectional flow area by blocking a portion of the flow area through the slashface outlet 147. The partial plug 149 may be designed so that it reduces the flow area to a desired or predetermined flow area. In one preferred embodiment, the partial plug 149 is formed with a central aperture such that it formed an approximate “doughnut” shape. The central aperture is formed to provide the desired flow area through the slashface outlet 147. As stated above, the predetermined cross-sectional flow area may relate to a desired coolant impingement characteristic and/or a desired metering characteristic, as one of ordinary skill in the art will appreciate. The partial plug 149 may be made of conventional materials and installed using conventional methods (i.e., welding, brazing, etc.). Once installed, an outer face of the partial plug 149 may reside flush in relation to the surface of the pressure side slashface 126 or suction side slashface 122. In some embodiments, it may be desirable to block flow through a slashface outlet 147 completely. In this case, a plug 149 that blocks the flow completely (which, as used herein, will be referred to as a “full plug”) may be used.

At the topside 113 of the platform 110, each of the cooling apertures 140 includes a topside outlet 145. The topside outlet 145 may be configured to have a predetermined cross-sectional flow area. In preferred embodiments, the predetermined cross-sectional flow area corresponds to at least one of a desired metering characteristic or a desired film cooling characteristic for each topside outlet 145. It will be appreciated by those of skill in the art that coolant released from the topside outlets 145 may be useful in that it may provide a layer that protects the platform 110 from the higher temperatures of the working fluid. This type of cooling is typically referred to as “film cooling” and the manner in which coolant is released into the hot gas path may affect the efficiency of this strategy. It will be appreciated that the topside outlets 145 may be configured to improve film cooling performance. In some embodiments, each of the topside outlets 145 of the cooling apertures 140 may include a plug 149. The plug 149 may be configured to create a predetermined or desirable cross-sectional flow area through the topside outlets 145.

In one preferred embodiment, as depicted in FIG. 7, the plurality of linear plenums 132 comprises three linear plenums 132: a forward linear plenum 132, a middle linear plenum 132, and an aft linear plenum 132. In this case, the forward linear plenum 132 may extend obliquely downstream from a forward position on the pressure side slashface 126 to a terminating point at the connection made with the interior cooling passage 116 in proximity to the middle region of the airfoil 102. The middle linear plenum 132 may extend obliquely downstream from a mid-axial position on the pressure side slashface 126 to an aft position on the suction side slashface 122 and, therebetween, the middle linear plenum 132 may bisect the interior cooling passage 116. The aft linear plenum 132 may extend obliquely downstream from a position on the pressure side slashface 126 to a position on an aft edge 121 of the platform 110 and, therebetween, the aft linear plenum 132 may bisect the interior cooling passage 116. Each of the linear plenums 132 may include a plurality of cooling apertures 140 extending therefrom, with the middle 132 and aft linear plenum 132 including at least a plurality of cooling apertures 140 on the pressure side of the platform 110 and a plurality of the cooling apertures 140 on the suction side of the platform 110.

The present invention further includes a novel method of forming interior cooling channels within the platform region of a rotor blade in a cost-effective and efficient manner. Referring to flow diagram 200 of FIG. 11, as an initial step 202, the linear plenum 132 may be formed in the pressure side or suction side slashface of the platform 110. Specifically, the linear plenum 132 may be formed using a conventional line-of-sight machining or drilling process from a highly accessible location (i.e., either the suction side slashface 122 or the pressure side slashface 126). Thus, expensive casting processes that must be used to form conventional intricate designs may be avoided.

Once the linear plenum 132 is formed, at a step 204, the cooling apertures 140 may be formed similarly using a conventional line-of-sight machining or drilling process. Again, the machining process may be initiated from an accessible location (i.e., the topside 113 of the platform 110).

Separately, as necessary, partial or full plugs 149 may be fabricated at a step 206. As discussed above, the partial plugs may have several different configurations and function to reduce the flow area of an outlet. The full plug may be formed to completely block the flow area of the outlet. The plugs 149 may be fabricated from conventional materials. Finally, at a step 208, the plugs 149 may be installed in predetermined locations. This may be done using conventional methods, such as welding, brazing, or mechanical attachment.

In operation, it will be appreciated that the linear plenum 132 and the cooling apertures 140 may be configured to direct a supply of coolant from the interior cooling passage 116 to a plurality of outlets 145, 147 formed on the pressure side slashface 126, the suction side slashface, and/or platform topside 113. More particularly, the platform cooling arrangement of the present invention extracts a portion of the coolant from the cooling passages 116, uses the coolant to remove heat from the platform 110, and then expels the coolant into the slashface cavity and across the topside of the platform such that the coolant is used efficiently to cool the interior region of the platform and the slashface cavity formed with the neighboring blade (as well as reducing the ingestion of hot gas path fluids). In addition, the coolant is used to provide film cooling to the surface of the platform 110. The present invention provides a mechanism to actively cool the platform region of a combustion turbine rotor blade by efficiently forming a complex, effective cooling arrangement using a series of cost-effective, conventional techniques. As stated, this region is typically difficult to cool and, given the mechanical loads of the area, is a location that receives high distress, particularly as engine firing temperatures are further increased. Accordingly, this type of active platform cooling is a significant enabling technology as higher firing temperatures, increased output, and greater efficiency are sought. Further, it will be appreciated that the usage of post-cast processes in the formation of the platform cooling channels provides greater flexibility to redesign, reconfigure, or retrofit platform cooling arrangements. Finally, the present invention teaches the simplified/cost-effective formation of platform cooling channels that have complex geometries and effective platform coverage. Whereas before, complex geometries necessarily meant a costly investment casting process or the like, the present application teaches methods by which cooling channels having complex design may be formed through the combination of several uncomplicated machining and/or casting processes.

As one of ordinary skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, all of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes, and modifications. Such improvements, changes, and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

We claim:

1. A platform cooling arrangement in a turbine rotor blade having a platform at an interface between an airfoil and a root, wherein the rotor blade includes an interior cooling passage that extends from the root to at least the approximate radial height of the platform, and wherein, along a side that corresponds with a pressure face of the airfoil, a pressure side of the platform comprises a substantially planar topside that extends circumferentially from the airfoil to a pressure side slashface, and, along a side that corresponds with a suction face of the airfoil, a suction side of the platform comprises a substantially planar topside that extends circumferentially from the airfoil to a suction side slashface; the platform cooling arrangement comprising:
a linear plenum residing just inboard of the planar topside and linearly extending through the platform from either the pressure side slashface or the suction side slashface to a connection with the interior cooling passage, the linear plenum having a longitudinal axis that is approximately parallel to the planar topside; and
a plurality of cooling apertures linearly extending from a topside outlet formed on the topside of the platform to a connection with the linear plenum, wherein the cooling apertures are configured such that each forms an acute angle with the topside of the platform.

2. The platform cooling arrangement according to claim 1, wherein the acute angle formed between the longitudinal axis of each cooling aperture and the topside of the plenum comprises an angle of less than 60°; and
wherein, in relation to the axial location of the connection each cooling aperture makes with the linear plenum, the corresponding topside outlet comprises a downstream location.

3. The platform cooling arrangement according to claim 1, wherein the acute angle formed between the longitudinal axis of each cooling aperture and the topside of the plenum comprises an angle of less than 45°;
wherein, in relation to the axial location of the connection each cooling aperture makes with the linear plenum, the corresponding topside outlet comprises a downstream location; and
wherein the cooling apertures are approximately parallel.

4. The platform cooling arrangement according to claim 2, wherein the platform cooling arrangement comprises a plurality of linear plenums and is configured such that the cross-sectional flow area of the cooling apertures is less than the cross-sectional flow area of the linear plenums;
wherein each of the linear plenums extends diagonally across the platform from a position on the pressure side slashface, the diagonal path including an axial-downstream and a circumferential directional component; and
wherein, from the position on the pressure side slashface, each of the linear plenums forms an acute plenum angle with the pressure side slashface, the acute plenum angle comprising a value of between 45° and 90°.

5. The platform cooling arrangement according to claim 2, wherein the platform cooling arrangement comprises a plurality of linear plenums and is configured such that the cross-sectional flow area of the cooling apertures is less than the cross-sectional flow area of the linear plenums;
wherein each of the linear plenums extends diagonally across the platform from a position on the pressure side slashface, the diagonal path including an axial-downstream and a circumferential directional component; and
wherein, from the position on the pressure side slashface, each of the linear plenums forms an acute plenum angle with the pressure side slashface, the acute plenum angle comprising a value of between 60° and 75°.

6. The platform cooling arrangement according to claim 4, wherein:
the plurality of linear plenums comprises at least two linear plenums, a first linear plenum and a second linear plenum;
the first linear plenum extends from a position on the pressure side slashface to a terminating point at the connection made with the interior cooling passage;
the second linear plenum extends from a position on the pressure side slashface across the platform to a position on the suction side slashface and, therebetween, bisects the interior cooling passage; and
wherein each of the first and second linear plenums include a plurality of cooling apertures extending therefrom, with the second linear plenum including a plurality of cooling apertures on the pressure side of the platform and a plurality of the cooling apertures on the suction side of the platform, wherein the cooling apertures are configured to expel coolant in an approximate downstream direction.

7. The platform cooling arrangement according to claim 6, wherein, in relation to the pressure side slashface and the suction side slashface, the cooling apertures extend diagonally from the connection with the linear plenum, the diagonal path including an axial-downstream and a circumferential directional component, wherein the circumferential directional component of the cooling apertures is opposite of the circumferential directional component of the linear plenum from which the cooling aperture extends.

8. The platform cooling arrangement according to claim 7, wherein the cooling apertures are approximately parallel to each other and approximately perpendicular to the linear plenum from which each extends; and
wherein each of the cooling apertures of the first plenum comprise either a short length or long length, and the cooling apertures of the first plenum comprise an alternating short/long configuration, the short length comprising approximately 40%-60% of the long length.

9. The platform cooling arrangement according to claim 6,
the first linear plenum comprises a slashface outlet on the pressure side slashface, the slashface outlet comprising a reduced cross-sectional flow area;
the second linear plenum comprises a slashface outlet on the pressure side slashface and a slashface outlet on the suction side slashface, the slashface outlet on the pressure side slashface being forward of the slashface outlet on the suction side slashface, and both slashface outlets comprising a reduced cross-sectional flow area;
the reduced cross-sectional flow area comprises a cross-sectional flow area that is less than the cross-sectional flow area through the linear plenum the slashface outlet serves;
each of the slashface outlets of reduced cross-sectional flow area comprises a predetermined cross-sectional flow area, the predetermined cross-sectional flow area corresponding to at least one of a desired coolant impingement characteristic and a desired metering characteristic for each slashface outlet.

10. The platform cooling arrangement according to claim 9, wherein the slashface outlets of the first and second linear plenums each comprise a plug, the plug comprising a non-integral plug that is configured to form the predetermined cross-sectional flow area; and
wherein at least one of the plugs comprises a full plug and one of the plugs comprises a partial plug.

11. The platform cooling arrangement according to claim 6, wherein, at the topside of the platform, each of the cooling apertures comprises a topside outlet of predetermined cross-sectional flow area; and
wherein the predetermined cross-sectional flow area corresponds to at least one of a desired film cooling characteristic and a desired metering characteristic for each topside outlet.

12. The platform cooling arrangement according to claim 8, wherein, at the topside of the platform, each of the cooling apertures comprises a plug, the plug configured to form the predetermined cross-sectional flow area.

13. The platform cooling arrangement according to claim 4, wherein:
the plurality of linear plenums comprises three linear plenums: a forward linear plenum, a middle linear plenum, and an aft linear plenum;
the forward linear plenum extends obliquely downstream from a forward position on the pressure side slashface to a terminating point at the connection made with the interior cooling passage in proximity to the middle region of the airfoil;
the middle linear plenum extends obliquely downstream from a mid-axial position on the pressure side slashface to an aft position on the suction side slashface and, therebetween, bisects the interior cooling passage;
the aft linear plenum extends obliquely downstream from a position on the pressure side slashface to a position on an aft edge of the platform and, therebetween, bisects the interior cooling passage; and
each of the linear plenums includes a plurality of cooling apertures extending therefrom, with the middle and aft linear plenum including at least a plurality of cooling apertures on the pressure side of the platform and a plurality of the cooling apertures on the suction side of the platform, wherein the cooling apertures are configured to expel coolant in an approximate downstream direction.

14. A method of creating a platform cooling arrangement in a turbine rotor blade having a platform at an interface between an airfoil and a root, wherein the rotor blade includes an interior cooling passage that extends from the root to at least the approximate radial height of the platform, and wherein, along a side that corresponds with a pressure face of the airfoil, a pressure side of the platform comprises a planar topside that extends circumferentially from the airfoil to a pressure side slashface and, along a side that corresponds with a suction face of the airfoil, a suction side of the platform comprises a planar topside that extends circumferentially from the airfoil to a suction side slashface; the method comprising the steps of:
machining at least one linear plenum, the linear plenum configured to reside just inboard of the planar topside and linearly extend through the platform from a starting point at a position on either the pressure side slashface or the suction side slashface to a connection with the interior cooling passage, the linear plenum having a longitudinal axis that is approximately parallel to the planar topside; and
machining a plurality of cooling apertures that linearly extend from a starting point at a position on the topside of the platform to a connection with the linear plenum, wherein the cooling apertures are configured such that each forms an acute angle with the topside of the platform, the acute angle comprising an angle of less than 60°.

15. The method according to claim 14, wherein the step of machining at least one linear plenum comprises machining at least a plurality of linear plenums;
wherein each of the linear plenums extends diagonally across at least about 50% of the circumferential width of the platform from a position on the pressure side slashface, the diagonal path including an axial-downstream and a circumferential directional component; and
wherein, from the position on the pressure side slashface, each of the linear plenums forms an acute plenum angle with the pressure side slashface, the acute plenum angle comprising a value of between 45° and 90°.

16. The method according to claim 15, wherein:
in relation to the axial location of the connection each cooling aperture makes with the linear plenum, the corresponding topside outlet comprises a downstream location;
the cooling apertures are approximately parallel; and
the cross-sectional flow area of the cooling apertures is less than the cross-sectional flow area of the linear plenum from which the cooling apertures extends.

17. The method according to claim 16, wherein:
the plurality of linear plenums comprises at least two linear plenums, a first linear plenum and a second linear plenum;
the first linear plenum extends from a position on the pressure side slashface to a terminating point at the connection made with the interior cooling passage;
the second linear plenum extends from a position on the pressure side slashface across the platform to a position on the suction side slashface and, therebetween, bisects the interior cooling passage; and
wherein each of the first and second linear plenums include a plurality of cooling apertures extending therefrom, with the second linear plenum including a plurality of cooling apertures on the pressure side of the platform and a plurality of the cooling apertures on the suction side of the platform, wherein the cooling apertures are configured to expel coolant in an approximate downstream direction.

18. The method according to claim 17, further comprising the steps of fabricating plugs of a predetermined configuration and plugging each of the slashface outlets formed from the machining of the first and second linear plenums with the fabricated plugs;
wherein the predetermined configuration of the plugs reduces the cross-sectional flow area from each of the slashface outlets such that, for each slashface outlet, at least one of a desired coolant impingement characteristic and a desired metering characteristic is achieved.

19. The method according to claim 17, wherein the step of machining the cooling apertures includes the step of machining a topside outlet having a predetermined cross-sectional flow area; and
wherein the predetermined cross-sectional flow area corresponds to at least one of a desired film cooling characteristic and a desired metering characteristic for each topside outlet.

20. The method according to claim 17, wherein the step of machining the cooling apertures includes the step of machining a topside outlet;
further comprising the steps of fabricating plugs of a predetermined configuration and plugging each of the topside outlets with one of the fabricated plugs;
wherein the predetermined configuration of the plugs reduces the cross-sectional flow area from each of the topside outlets such that, for each topside outlet, at least one of a desired film cooling characteristic and a desired metering characteristic is achieved.

21. The method according to claim 16, wherein:
the plurality of linear plenums comprises three linear plenums: a forward linear plenum, a middle linear plenum, and an aft linear plenum;
the forward linear plenum extends obliquely downstream from a forward position on the pressure side slashface to a terminating point at the connection made with the interior cooling passage in proximity to the middle region of the airfoil;
the middle linear plenum extends obliquely downstream from a mid-axial position on the pressure side slashface to an aft position on the suction side slashface and, therebetween, bisects the interior cooling passage;
the aft linear plenum extends obliquely downstream from a position on the pressure side slashface to a position on an aft edge of the platform and, therebetween, bisects the interior cooling passage; and
each of the linear plenums include a plurality of cooling apertures extending therefrom, with the middle and aft linear plenums including a plurality of cooling apertures on each of the pressure side of the platform and the suction side of the platform.
